(19) United States
(12) Patent Application Publication
(10) Pub. No.: US 2018/0082513 A1
(43) Pub. Date: Mar. 22, 2018

(54) MULTI-PLAYER INTERACTIVE ELECTRONIC GAMING TABLE

(71) Applicant: Gamblit Gaming, LLC, Glendale, CA (US)

(72) Inventors: Ivan Souffront, Sunland, CA (US); Zachary Foley, Los Angeles, CA (US)

(21) Appl. No.: 15/713,595

(22) Filed: Sep. 22, 2017

Related U.S. Application Data
(60) Provisional application No. 62/546,462, filed on Aug. 16, 2017.
(60) Provisional application No. 62/484,855, filed on Apr. 12, 2017.
(60) Provisional application No. 62/398,481, filed on Sep. 22, 2016.

(51) Int. Cl. G07F 17/32

(52) U.S. Cl. CPC G07F 17/322; G07F 17/3244; G07F 17/3211; G07F 17/3293

(57) ABSTRACT

A multiplayer interactive electronic gaming table is disclosed. The multiplayer interactive electronic gaming table includes an electronic gaming table controller, a symbol item storage device, one or more displays, two or more player interactive interfaces, and a latching circuit operatively connecting the two or more player interactive interfaces to the electronic gaming table controller. The electronic gaming table controller is configured to receive symbol data from the symbol storage device for a drawn symbol item, display the symbol data on the one or more displays, receive a player selection of the symbol item from one of the two or more player interactive interfaces via the latching circuit, assign the symbol item to a set of player symbol items associated with the player, prompt a dealer to provide the symbol item to the player, determine a game state using the symbol data, and display the game state.

### FIELD OF THE INVENTION

Embodiments of the invention are generally related to electronic gaming tables. More particularly, the invention relates to the processing of wagering events by electronic gaming tables.

### BACKGROUND

The gaming industry has traditionally developed data processing systems in the form of electronic gaming tables (EGTs) used to support simple wagering games with limited player interactivity. However, more complicated wagering processes with greater player interactivity need data processing systems that are better suited for implementing these more complicated interactive wagering processes. Various aspects of embodiments of the invention meet such a need.

### SUMMARY OF THE INVENTION

Systems and methods in accordance with embodiments of the invention provide a communication and data processing system constructed for a multiplayer interactive electronic gaming table.

In an embodiment, a multiplayer interactive electronic gaming table, comprises an electronic gaming table controller, a symbol item storage device operatively connected to the electronic gaming table, one or more displays operatively connected to the electronic gaming table controller, two or more player interactive interfaces, and a latching circuit operatively connecting the two or more player interactive interfaces to the electronic gaming table controller. The the electronic gaming table controller is configured to receive symbol data from the symbol storage device for a drawn symbol item, display the symbol data on the one or more displays, receive a player selection of the symbol item from one of the two or more player interactive interfaces via the latching circuit, assign the symbol item to a set of player symbol items associated with the player, prompt a dealer to provide the symbol item to the player, determine a game state using the symbol data, and display the game state using the one or more displays.

In some embodiments, the multiplayer interactive electronic gaming table further comprises a dealer interactive interface.

In various embodiments, the interactive electronic gaming table controller is further configured to use the dealer interactive interface to prompt the dealer.

In many embodiments, the electronic gaming table controller is further configured to implement an interactive wagering process for an interactive wagering game.

In an embodiment, the interactive wagering game is in the form of interactive poker.

In another embodiment, the interactive wagering game is in the form of interactive Black Jack.

In various embodiments, a multiplayer interactive electronic gaming table is disclosed. The multiplayer interactive electronic gaming table includes an electronic gaming table controller, a symbol item storage device, one or more displays, two or more player interactive interfaces, and a latching circuit operatively connecting the two or more player interactive interfaces to the electronic gaming table controller. The electronic gaming table controller is configured to receive symbol data from the symbol storage device for a drawn symbol item, display the symbol data on the one or more displays, receive a player selection of the symbol item from one of the two or more player interactive interfaces via the latching circuit, assign the symbol item to a set of player symbol items associated with the player, prompt a dealer to provide the symbol item to the player, determine a game state using the symbol data, and display the game state.

### BRIEF DESCRIPTION OF THE DRAWINGS

FIGS. 1A and 1B are diagrams of a structure of a multiplayer interactive electronic gaming table in accordance with various embodiments of the invention.

FIG. 2 is an architecture diagram of an electronic gaming table controller of a multiplayer interactive electronic gaming table in accordance with various embodiments of the invention.

FIG. 3 is a sequence diagram of interactions between components of a multiplayer interactive electronic gaming table in accordance with various embodiments of the invention.

FIG. 4 is a state diagram of a multiplayer interactive electronic gaming table during an interactive wagering process in accordance with various embodiments of the invention.

FIG. 5 is an activity diagram of a multiplayer interactive electronic gaming table during an interactive wagering process in accordance with various embodiments of the invention.

FIG. 6 is another activity diagram of a multiplayer interactive electronic gaming table during an interactive wagering process in accordance with various embodiments of the invention.

FIG. 7 is another state diagram of an interactive wagering process of a multiplayer interactive electronic gaming table during an interactive wagering process in accordance with various embodiments of the invention.

FIGS. 8A and 8B are activity diagrams of a multiplayer interactive electronic gaming table during another interactive wagering process in accordance with various embodiments of the invention.

FIG. 9A is an illustration of a multiplayer interactive electronic gaming table playing surface in accordance with various embodiments of the invention.

FIG. 9B is an illustration of a multiplayer interactive electronic gaming table playing display in accordance with various embodiments of the invention.

FIG. 10A is an illustration of another multiplayer interactive electronic gaming table playing surface in accordance with various embodiments of the invention.

FIG. 10B is an illustration of another multiplayer interactive electronic gaming table playing display in accordance with various embodiments of the invention.

### DETAILED DESCRIPTION

In some embodiments, an electronic gaming table controller provides a wagering user interface in the form of an interactive interface for a dealer and one or more players. The interactive interfaces are used to receive commands and display data for a wagering process and wagering outcome in accordance with an interactive wagering process. Many different types of interactive wagering processes may be implemented by the multiplayer interactive electronic gaming table.

In some embodiments, the interactive wagering process includes a skill-based game and the multiplayer interactive electronic gaming table detects a player's skillful interactions with an interactive interface of the multiplayer interactive electronic gaming table.

In various embodiments, wagers in accordance with the interactive wagering process may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In some embodiments, credits can be one or more credits in the form of chips issued and redeemed by an operator or the multiplayer interactive electronic gaming table.

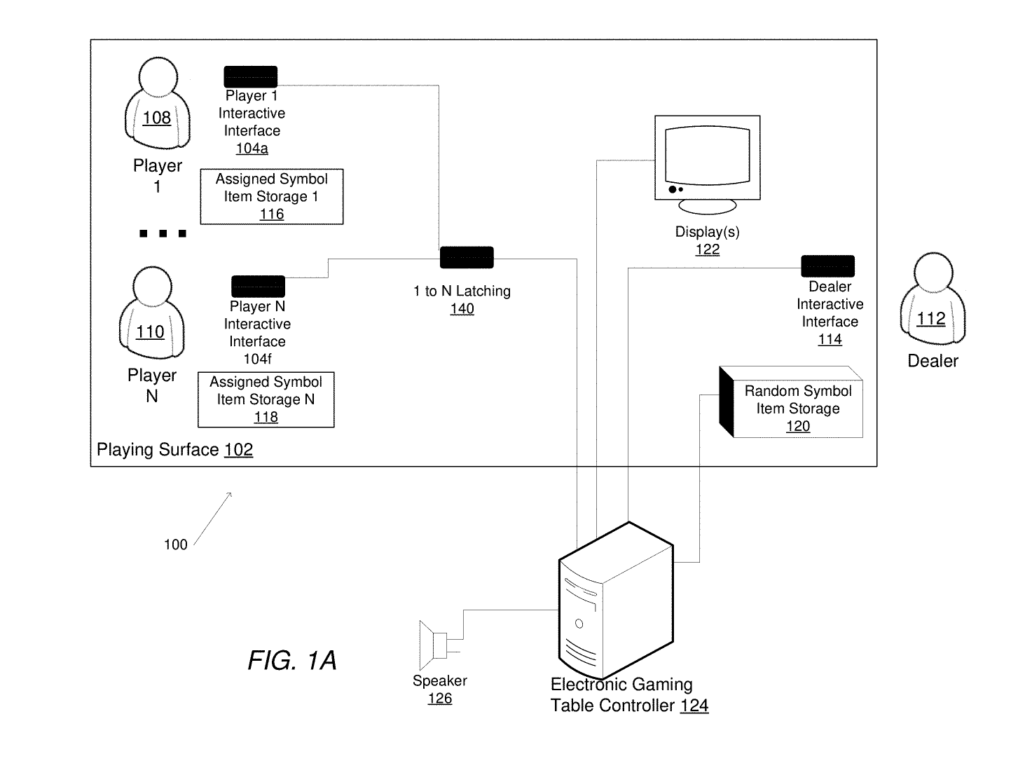

FIGS. 1A and 1B are diagrams of a structure of a multiplayer interactive electronic gaming table in accordance with various embodiments of the invention. In FIGS. 1A and 1B, identical element references reference the same element. The multiplayer interactive electronic gaming table 100 includes a playing surface 102 having one or more player interactive interface devices, such as player interface devices that are associated with one or more respective players, such as players 108 and 110, as player interactive interfaces, such as player interactive interfaces 104a, 104b, 104c, 104d, 104e and 104f. The playing surface 102 also has one or more dealer interactive interface devices associated with a dealer 112 as a dealer interactive interface 114. The playing surface includes one or more assigned symbol item storage locations, such as assigned symbol item storage locations 116 and 118, that are associated with the one or more players, such as players 108 and 110. A random symbol storage, providing, and scanning device 120 is located on the playing surface 102 in a location accessible to the dealer 112. The multiplayer interactive electronic gaming table 100 includes one or more display devices 122 used to display state data of an interactive wagering process that is being implemented on the multiplayer interactive electronic gaming table 100.

In many embodiments, the multiplayer interactive electronic gaming table 100 includes one or more audio output devices, such as speaker 126.

In some embodiments, the symbol item storage, providing and scanning device 120 is a playing card delivery shoe that stores a set of symbol items that are playing cards. The symbol item storage, providing and scanning device 120 scans each playing card as that playing card is drawn by a dealer. In an embodiment, an appropriate card delivery shoe is the iShoe Auto™ manufactured by Scientific Games Corporation having a corporate headquarters at 6601 S. Bermuda Avenue Las Vegas, Nev. 89119.

In some embodiments, the multiplayer interactive electronic gaming table includes a chip tray 130 for storing gambling chips or other types of tokens that are used during an interactive wagering process or gambling game implemented using the multiplayer interactive electronic gaming table. In many such embodiments, the playing surface includes locations for placement of the tokens during game play indicating a state of a respective player's wagering.

The one or more audio output devices 126; one or more player interactive interfaces 104a, 104b, 104c, 104d, 104e and 104f; the random symbol item storage, providing, and scanning device 120; the one or more dealer interactive interfaces 114; and the one or more display devices 122 are operatively connected to an electronic gaming table controller 124.

The random symbol item storage, providing, and scanning device 120 is operable to provide one or more randomly determined symbol items to the dealer 112 who in turn places the one or more symbol items in the one or more assigned symbol item storage locations associated with the one or more players. In addition, the random symbol item storage, providing, and scanning device 120 scans or reads each symbol item as it is provided to the dealer to determine a symbol associated with the symbol item. The random symbol item storage, providing, and scanning device 120 communicates data of each read or scanned symbol item to the electronic gaming table controller 124.

In some embodiments, the symbol items are playing cards having symbol indicia printed thereon. The random symbol item storage, providing, and scanning device 120 scans the symbol indicia using an optical scanner. In many such embodiments, the symbol indicia represent four suits, namely hearts; diamonds; clubs; and spades; and thirteen values, namely ace; king; queen; jack; 10; 9; 8; 7; 6; 5; 4; 3; and 2. In some embodiments, the symbol indicia are printed using fluorescing ink and the cards are illuminated using UV light when they are scanned by the random symbol item storage, providing, and scanning device 120.

In many embodiments, the symbol items are playing cards and the random symbol item storage, providing, and scanning device is an electronic playing card delivery shoe that reads each card, and the lights and sounds of multiplayer interactive electronic gaming table guide a dealer through steps of a multiplayer interactive wagering game being implemented using the multiplayer interactive electronic gaming table.

In some embodiments, the symbol items are one or more multi-sided die having symbol indicia on a plurality of external surfaces. The random symbol item storage, providing, and scanning device 120 scans the symbol indicia using an optical scanner. In some embodiments, the symbol indicia are printed using fluorescing ink and the die are illuminated using UV light when they are scanned by the random symbol item storage, providing, and scanning device 120.

Each of the player interactive interfaces is operatively connected to the electronic gaming table controller 124. Each player interactive interface includes at least one visual display device and each player interactive interface is operable by the player to communicate a player selection of a symbol item to the electronic gaming table controller 124.

In many embodiments, a latching circuit 140 operatively connects the player interactive interfaces to the electronic gaming table controller 124 and the latching circuit 140 allows only one player's symbol selection using the player interactive interfaces to be detected and transmitted to the electronic gaming table controller 124. The latching circuit 140 is operably connected to two or more momentary switches of a respective two or more player interactive interfaces and also operably connected to the electronic gaming table controller 124. In operation, the latching circuit 140 detects a first signal from a player's actuation of a respective momentary switch of the player's respective player interactive interface. The player actuates the momentary switch in order to select a symbol that has been drawn from the random symbol item storage, providing, and scanning device 120. The latching circuit 140 latches the first signal received from the one or more players actuating their respective momentary switches and transmits the latched signal to the electronic gaming table controller 124. At the same time, the latching circuit 140 locks out the momentary switches of any other player's respective player interactive interfaces.

In some embodiments, a visual display device of the player interactive interface includes an optical output device. In many embodiments, the visual display device is a light emitting diode (LED) or the like. The visual display device receives control signals communicated from the electronic gaming table controller 124 that cause the visual display device to turn on and off, thus emitting light visible to the respective player of the player interactive interface at the command of the electronic gaming table controller 124.

In many embodiments, a portion of the dealer interactive interface includes an optical display device that is visible to the dealer 112 and a respective player, such as optical display devices 128a, 128b, 128c, 128d, 128e and 128f, that are capable of being commanded to display light in at least two different colors. In an example embodiment, the portion of the player respective dealer interactive interface associated with the player and visible to the dealer includes a multicolor light emitting diode (LED) device that can be commanded to display two or more different colors. The optical display device is commanded to display a specified color of light to prompt the dealer 112 during an interactive wagering process. In an example embodiment, the optical display device is commanded to display a first color of light when the respective player is to receive a drawn symbol item that was selected by the player, the optical display device is commanded to display a second color of light when the respective player has successfully achieved an objective of the interactive wagering process, and the optical display device is commanded to display a third color of light when the respective player is no longer allowed to participate in the interactive wagering process.

In some embodiments, a dealer is prompted using audio prompts. One or more audio output devices are commanded to prompt the dealer to provide a drawn symbol item that was selected by the player, to prompt the dealer to provide a payout when a player has successfully achieved an objective of the interactive wagering process, and to prompt the dealer when a player is no longer allowed to participate in the interactive wagering process.

In some embodiments, the player interactive interface includes a momentary switch operable by the player to indicate their selection of a symbol item to the electronic gaming table controller 124.

In various embodiments, a player interactive interface includes input devices such as, but not limited to, buttons or keys; keyboards; keypads; game controllers; joysticks; computer mice; track balls; track buttons; touch pads; touch screens; accelerometers; motion sensors; video input devices; microphones; and the like. In various embodiments, a player interactive interface includes output devices such as, but not limited to, audio output devices such as speakers, headphones, earbuds, and the like; visual output devices such as lights, video displays and the like; and tactile devices such as rumble pads, hepatic touch screens, buttons, keys and the like.

The one or more displays 122 are operatively connected to the electronic gaming table controller 124. The electronic gaming table controller 124 determines a game state for an interactive wagering process on the basis of data communicated from the one or more player interactive interfaces 104a, 104b, 104c, 104d, 104e and 104f and the random symbol item storage, providing, and scanning device 120 and generates display data of the game state using the data communicated from the one or more player interactive interfaces 104a, 104b, 104c, 104d, 104e and 104f and the random symbol item storage, providing, and scanning device 120. The electronic gaming table controller 124 communicates the display data to the one or more displays 122 and the one or more displays 122 generate a game state display using the display data that is displayed to the one or more players.

In some embodiments, a dealer interactive interface 114 is provided to the dealer. The dealer interactive interface 114 is operatively connected to the electronic gaming table controller 124. The dealer interactive interface 114 includes at least one visual display device and is operable by the dealer to communicate dealer interactions with the electronic gaming table to the electronic gaming table controller 124.

In some embodiments, the visual display device is an optical output device such as a light emitting diode (LED) or the like. The visual display device receives control signals communicated from the electronic gaming table controller 124 that cause the visual display device to turn on and off, thus emitting light visible to the dealer at the command of the electronic gaming table controller 124.

In various embodiments, the dealer interactive interface 114 includes input devices such as, but not limited to, buttons or keys; keyboards; keypads; game controllers; joysticks; computer mice; track balls; track buttons; touch pads; touch screens; accelerometers; motion sensors; video input devices; microphones; and the like. In various embodiments, the dealer interactive interface 114 includes output devices such as, but not limited to, audio output devices such as speakers, headphones, earbuds, and the like; visual output devices such as lights, video displays and the like; and tactile devices such as rumble pads, hepatic touch screens, buttons, keys and the like.

In various embodiments, the playing surface 102 further includes one or more wager indicator locations 144a, 144b, 144c, 144d, 144e, and 144f that indicate to respective players where to place wagering tokens to indicate to a dealer what the intended wagers of the players.

In some embodiments, the player surface 102 further includes one or more openings 146 into which the dealer 112 drops currency when the players cash in by exchanging currency for wagering tokens such as chips.

In various embodiments, the playing surface further includes one or more text or graphic icons 150a to 150i used to communicate payouts for various events of an interactive wagering process.

In some embodiments, one or more components of an electronic gaming table controller 124 are housed in an enclosure such as a housing, cabinet, casing or the like. The enclosure further includes one or more player accessible openings or surfaces that constructed to mount player interface input devices and/or player interface output devices.

In many embodiments, the electronic gaming table controller 124 may additionally include various audit logs, activity meters, and interactive wagering process event data stores. In an embodiment, the electronic gaming table controller 124 stores data of symbol items that are provided to the dealer and which player, if any, has selected the provided symbol item.

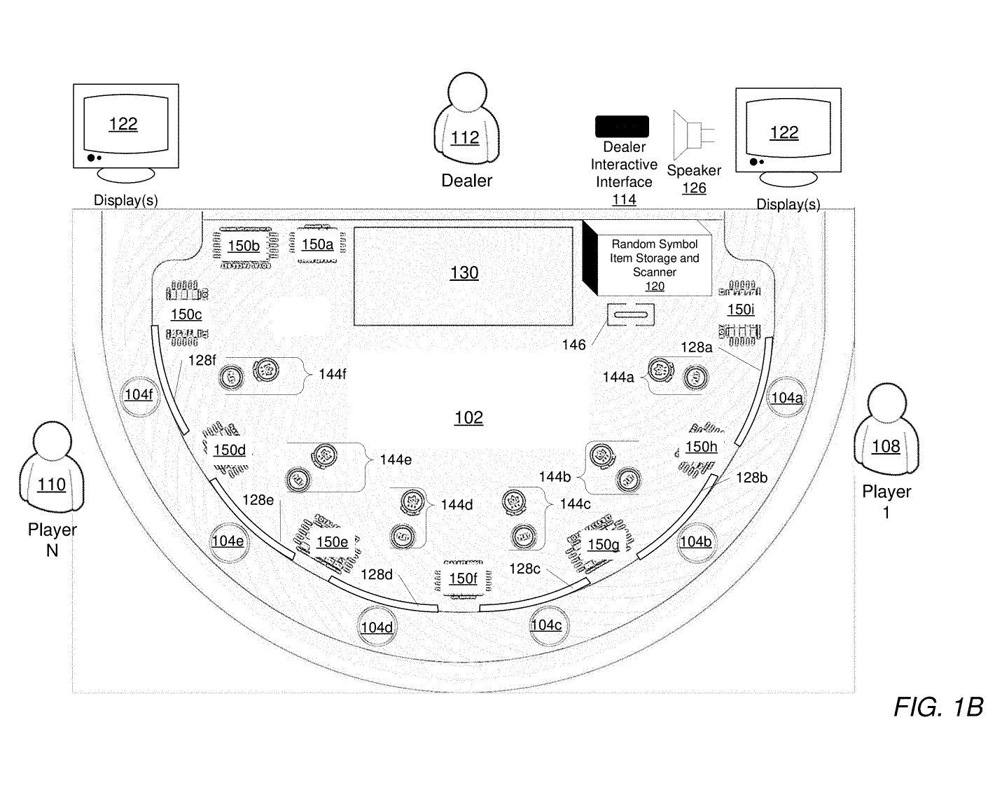

FIG. 2 is a diagram of a structure of an electronic gaming table controller, of an a multiplayer interactive electronic gaming table in accordance with various embodiments of the invention. An electronic gaming table controller may be constructed from or configured using one or more processing devices that perform the operations of the electronic gaming table controller. In many embodiments, a electronic gaming table controller can be constructed from or configured using various types of processing devices including, but not limited to, an electronic gaming machine processor, a general purpose computer, a computing device, a controller, a server, or the like. An electronic gaming table controller 200 includes a bus 202 that provides an interface for one or more processors 204, random access memory (RAM) 206, read only memory (ROM) 208, machine-readable storage medium 210, one or more user output devices 212, one or more user input devices 214, and one or more communication interface devices 216.

The one or more processors 204 may take many forms, such as, but not limited to: a central processing unit (CPU); a multi-processor unit (MPU); an ARM processor; a controller; a programmable logic device; or the like.

In the example embodiment, the one or more processors 204 and the random access memory (RAM) 206 form an electronic gaming table controller processing unit 299. In some embodiments, the electronic gaming table controller processing unit includes one or more processors operatively connected to one or more of a RAM, ROM, and machine-readable storage medium; the one or more processors of the electronic gaming table controller processing unit receive instructions stored by the one or more of a RAM, ROM, and machine-readable storage medium via a bus; and the one or more processors execute the received instructions. In some embodiments, the electronic gaming table controller processing unit is an ASIC (Application-Specific Integrated Circuit). In some embodiments, the electronic gaming table controller processing unit is a SoC (System-on-Chip).

Examples of output devices 212 include, but are not limited to, display screens; light panels; and/or lighted displays. In accordance with particular embodiments, the one or more processors 204 are operatively connected to audio output devices such as, but not limited to: speakers; and/or sound amplifiers. In accordance with many of these embodiments, the one or more processors 204 are operatively connected to tactile output devices like vibrators, and/or manipulators.

Examples of user input devices 214 include, but are not limited to: tactile devices including but not limited to, keyboards, keypads, foot pads, touch screens, and/or trackballs; non-contact devices such as audio input devices; motion sensors and motion capture devices that the electronic gaming table controller can use to receive inputs from a player when the player interacts with the electronic gaming table controller; physiological sensors that monitor the physiology of the player; environmental sensors that monitor the physical environment of the electronic gaming table controller; accelerometers that monitor changes in motion of the electronic gaming table controller; and location sensors that monitor the location of the electronic gaming table controller such as global positioning sensors.

The one or more communication interface devices 216 provide one or more wired or wireless interfaces for communicating data and commands between the electronic gaming table controller 400 and other devices that may be included in a multiplayer interactive electronic gaming table. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 210 stores machine-executable instructions for various components of the electronic gaming table controller, such as but not limited to: an operating system 218; one or more device drivers 222; one or more application programs 220 including but not limited to an interactive application; and multiplayer interactive electronic gaming table electronic gaming table controller instructions and data 224 for use by the one or more processors 204 to provide the features of an electronic gaming table controller as described herein. In some embodiments, the machine-executable instructions further include application control interface/application control interface instructions and data 226 for use by the one or more processors 204 to provide the features of an application control interface/application control interface as described herein.

In various embodiments, the machine-readable storage medium 210 is one of a (or a combination of two or more of) a hard drive, a flash drive, a DVD, a CD, a flash storage, a solid state drive, a ROM, an EIEPROM, and the like.

In operation, the machine-executable instructions are loaded into memory 206 from the machine-readable storage medium 210, the ROM 208 or any other storage location. The respective machine-executable instructions are accessed by the one or more processors 204 via the bus 202, and then executed by the one or more processors 204. Data used by the one or more processors 204 are also stored in memory 206, and the one or more processors 204 access such data during execution of the machine-executable instructions. Execution of the machine-executable instructions causes the one or more processors 204 to control the electronic gaming table controller 400 to provide the features of a multiplayer interactive electronic gaming table electronic gaming table controller as described herein

Although the electronic gaming table controller is described herein as being constructed from or configured using one or more processors and instructions stored and executed by hardware components, the electronic gaming table controller can be constructed from or configured using only hardware components in accordance with other embodiments. In addition, although the storage medium 210 is described as being operatively connected to the one or more processors through a bus, those skilled in the art of electronic gaming table controllers will understand that the storage medium can include removable media such as, but not limited to, a USB memory device, an optical CD ROM, magnetic media such as tape and disks. In some embodiments, the storage medium 210 can be accessed by the one or more processors 204 through one of the communication interface devices 216 or using a communication link. Furthermore, any of the user input devices or user output devices can be operatively connected to the one or more processors 204 via one of the communication interface devices 216 or using a communication link.

In some embodiments, the electronic gaming table controller 200 can be distributed across a plurality of different devices. In many such embodiments, an electronic gaming table controller of a multiplayer interactive electronic gaming table includes an interactive application server operatively connected to an interactive client using a communication link. The interactive application server and interactive application client cooperate to provide the features of an electronic gaming table controller as described herein.

In various embodiments, the electronic gaming table controller 200 may be used to construct other components of a multiplayer interactive electronic gaming table as described herein.

In some embodiments, components of an electronic gaming table controller may be constructed from or configured using a single device using processes that communicate using an interprocess communication protocol. In other such embodiments, the components of an electronic gaming table controller of a multiplayer interactive electronic gaming table may communicate by passing messages, parameters or the like.

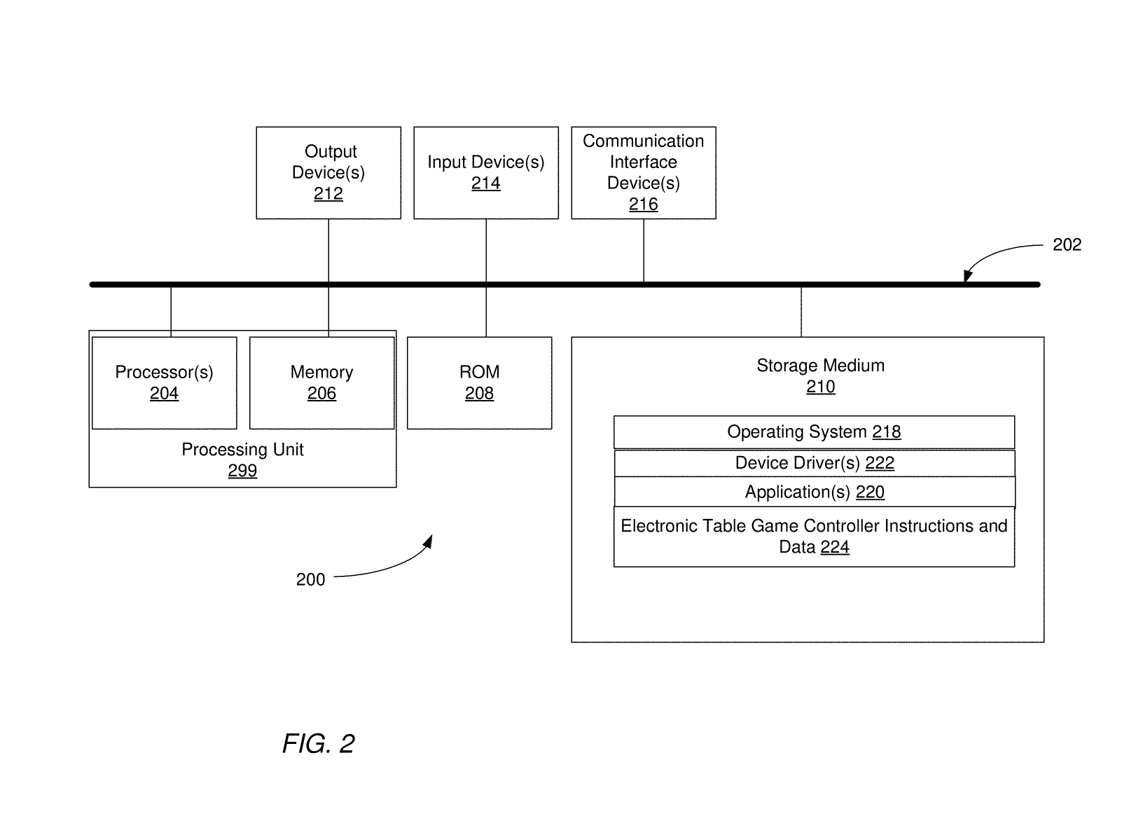

FIG. 3 is a sequence diagram of interactions between components of a multiplayer interactive electronic gaming table in accordance with various embodiments of the invention. The components of the multiplayer interactive electronic gaming table include a random symbol item storage, providing, and scanning device 300 operably connected to an electronic table game controller 302. The electronic table game controller 302 is also operably connected to one or more displays 304, one or more dealer interactive interfaces 307 two or more player interactive interfaces, such as interactive interface 1 308 and interactive interface N 310. Each dealer interactive interface includes one or more visual display devices and one or more user input devices used to communicate events to the electronic table game controller 302. Each player interactive interface includes one or more visual display devices and each player interactive interface includes one or more user input devices operable by a respective player to communicate a player selection of a symbol item to the electronic gaming table controller. The electronic table game controller is operably connected to the two or more player interactive interfaces by a latching circuit 306 as described herein.

In many embodiments, the latching circuit is used to allow only one player's symbol selection to be detected and transmitted to an electronic gaming table controller. In some embodiments, the latching circuit is operably connected to two or more momentary switches of a respective two or more player interactive interfaces and also operably connected to the electronic gaming table controller.

In operation, the random symbol item storage, providing, and scanning device 300 detects 312 that a symbol item is being withdrawn for presentation to two or more players. Data of the drawn symbol item 314 is communicated by the random symbol item storage, providing, and scanning device 300 to the electronic table game controller 302. The electronic table game controller 302 receives the drawn symbol item data 314 and generates drawn symbol item display data 316 using the drawn symbol item data and communicates the drawn symbol item display data 316 to the one or more displays 304. The one or more displays 304 receive the drawn symbol item display data and use the drawn symbol item display data to generate a display 317 of the drawn symbol item so that the two or more players can see the drawn symbol item.

The electronic table game controller 302 uses the drawn symbol item data to determine 318 state data of an interactive wagering process, such as a game state, during a wagering session. Determination of the state data includes, but is not limited to, determining a state of a side wager based on a dealer symbol item set, determining a state of a side wager based on one or more player symbol item sets, determining a currently winning player as between the two or more players based on ranking respective player symbol item set associated with the players, determining a state of a side wager based on one or more player symbol item sets, determining a currently winning player as between the two or more players based on ranking respective player symbol item set associated with the players, etc. The electronic table game controller 302 uses the state data to generate state display data 320 that is communicated to the one or more displays 304. The one or more displays 304 receive the state display data 320 and use the state display data to generate an interactive wagering process state display that is displayed 322 to the two or more players.

The electronic table game controller 302 uses the state data to generate one or more prompts for a dealer that guide the dealer in a next action to be taken by the dealer in response to the state data of the interactive wagering process. Data of the one or more dealer prompts 324 is communicated to the dealer interactive interface 307. The dealer interactive interface 307 receives data of the one or more prompts and updates a display of the dealer interactive interface 307 based on the data of the one or more prompts.

The electronic table game controller 302 communicates data of portions of the state data, such as player 1 state display data 326 and player n state display data 328, to the two or more player interactive interfaces 308 and 310. The interactive interfaces 308 and 310 receive the state data and use the state data to display a portion of the sate data to the two or more players, respectively. In some embodiments, the portions of the state data are unique for the two or more players. In an example embodiment, the portion of the state data communicated to currently winning player may include data indicating that the currently winning player is currently winning. In another example embodiment, the portion of the state data communicated to a locked out player may include data indicating that the locked player may no longer select symbol items for inclusion in the locked out player's player symbol item set.

During the interactive wagering process, each of the player interactive interfaces 308 and 310 communicates player interaction data, such as interaction data 330 and interaction data 332, to the latching circuit 306. In an example embodiment, the interaction data indicates whether or not a respective player has selected a drawn symbol item that is being presented to the one or more players. When the latching circuit 306 receives the player interaction data from a first player interactive interface, the latching circuit latches the first received interaction data and communicates that first interaction data 334 to the electronic table game controller. In addition, the latching circuit locks out any subsequent interaction data that might be received from any of the other two or more player interactive interfaces.

The electronic table game controller 302 receives the interaction data 334 and determines 336 new game state data of the interactive wagering process using the interaction data. The electronic table game controller uses the new state data to generate new state display data that is communicated to the one or more displays. The one or more displays receive the new state display data and generate a game state display that is displayed to the one or more players, using the new state display data.

The electronic table game controller uses the state data to generate one or more prompts for a dealer that guide the dealer in a next action to be taken by the dealer in response the game state. Data of the one or more dealer prompts 338 is communicated to the dealer interactive interface. The dealer interactive interface receives data of the prompts 338 and updates a display of the dealer interactive interface based on the data of the one or more prompts.

The electronic table game controller uses the new state data to generate new player state display data that is communicated to the two or more player interactive interfaces. The two or more player interactive interfaces receive the new player state display data and generate a game state display that is displayed to the one or more players, using the new player state display data.

The process repeats until the electronic table game controller determines, from a set of rules for the wagering process or game that the electronic gaming table controller is implementing, that the wagering process or the game is completed.

In many embodiments, the one or more prompts for the dealer generated from the state data by the electronic game controller include an audio portion that is communicated to a speaker or other sound output device for presentation to the dealer.

In some embodiments, a visual display device of the player interactive interface includes an optical output device. In many embodiments, the visual display device is a light emitting diode (LED) or the like. The visual display device receives control signals communicated from the electronic gaming table controller that cause the visual display device to turn on and off, thus emitting light visible to the respective player of the player interactive interface at the command of the electronic gaming table controller.

In many embodiments, a portion of the dealer interactive interface includes an optical display device that is visible to the dealer and a respective player that are capable of being commanded to display light in two or more different colors. In an example embodiment, the portion of the player respective dealer interactive interface associated with the player and visible to the dealer includes a multicolor light emitting diode (LED) device that can be commanded to display two or more different colors. The optical display device is commanded to display a specified color of light to prompt the dealer during an interactive wagering process. In an example embodiment, the optical display device is commanded to display a first color of light when the respective player is to receive a drawn symbol item that was selected by the player, the optical display device is commanded to display a second color of light when the respective player has successfully achieved an objective of the interactive wagering process, and the optical display device is commanded to display a third color of light when the respective player is locked out and no longer allowed to participate in the interactive wagering process.

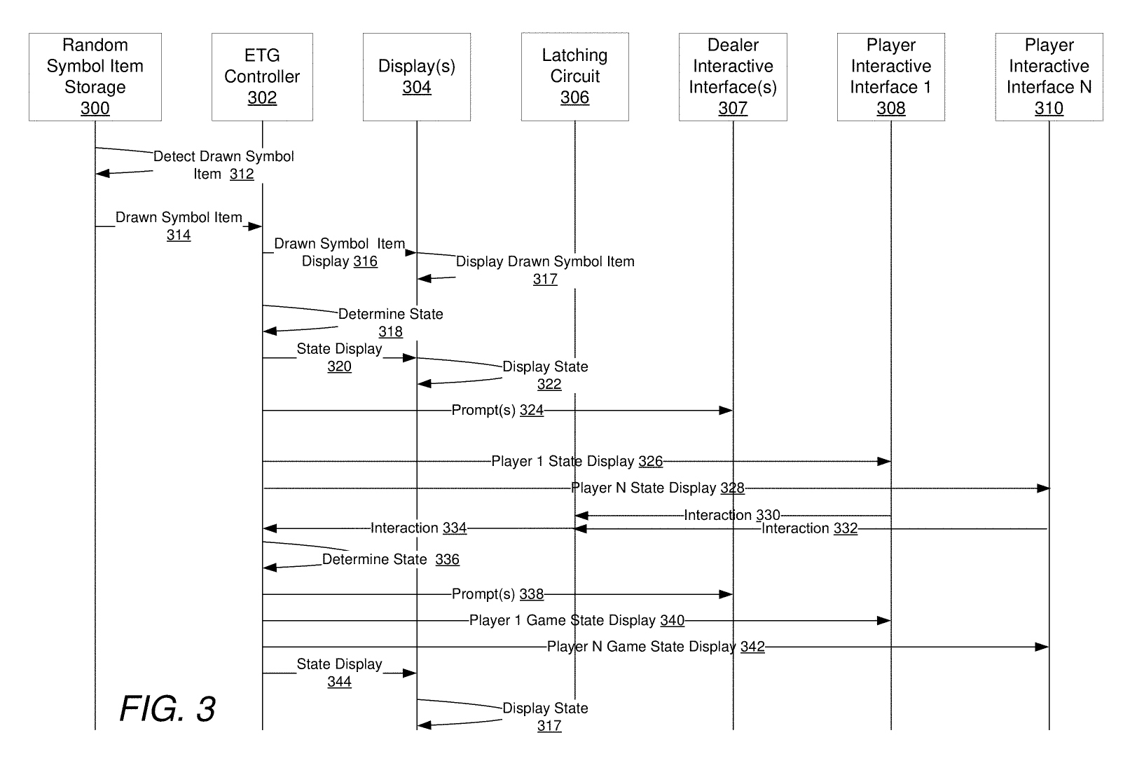

FIG. 4 is a state diagram of a multiplayer interactive electronic gaming table during an interactive wagering process in accordance with various embodiments of the invention. The interactive wagering process is for a form of interactive poker implemented on the multiplayer interactive electronic gaming table wherein in the ranking of player symbol item sets is based on poker as described herein. In an example embodiment, during an initial symbol item assignment subprocess, the multiplayer interactive electronic gaming table assigns one more initial symbol items to two or more players. The initial symbol items are added to each player's respective player symbol item set. Subsequently, in a player versus player interactive subprocess, additional symbol items are drawn and presented to the two or more players. The two or more players compete to select the drawn and presented symbol items to add to their respective player symbol item sets. After all player's have had a chance to obtain a player symbol item set, the multiplayer interactive electronic gaming table ranks the player symbol item sets and a player with a highest ranked player symbol item set is declared a winner and awarded an award. In some embodiments, the initial symbol item assignment subprocess by the multiplayer interactive electronic gaming table is a basis of a house-banked wager. In various embodiments, the player versus player interactive subprocess, is a basis for a house-rake player versus player wager.

In some embodiments, the symbol items are playing cards having four suits with each suit including, in ranked order, an ace, three face cards, namely a king; a queen; and a jack; and 9 valued non-face cards having values of 10; 9; 8; 7; 6; 5; 4; 3; and 2.

In various embodiments, a completed player symbol item set will have three playing cards. The rules of 3-card poker are used to rank the player symbol item set, from highest to lowest ranking: straight flush; three of a kind; straight; flush; pair; high card. In some embodiments, the suits are ranked. In some embodiments, the suits in ranked order are from highest to lowest: spades; hearts; diamonds; and clubs.

During the interactive wagering process, in an initial state I 400, a dealer draws symbol items from a randomized set of symbol items stored in a random symbol item storage, providing, and scanning device. The multiplayer interactive electronic gaming table assigns at least one symbol item to respective player symbol item sets of two or more players. The initial drawing of the symbol items is non-deterministic and chance-based as indicated by chance-based transition P(I) 401, and forms the basis of determining an achievement of a chance-based objective of the two or more player's winning a house-banked wager with an operator of the multiplayer interactive electronic gaming table. If the chance-based objective is achieved, the multiplayer interactive electronic gaming table transitions, as indicated by chance-based transition P(Ai) 403 to an objective achievement state Ai 402, and each of the two or more players is awarded an award. However, if the chance-based objective is not achieved, the multiplayer interactive electronic gaming table transitions to loss state Li 404 as indicated by chance-based transition 1-P(Ai) 405. From either state Ai 402 or Li 404, the multiplayer interactive electronic gaming table transitions to a skill-based objective state On 406 where the two or more player's attempt to skillfully achieve a competitive multiplayer skill objective. While in state On 406, the multiplayer interactive electronic gaming table assigns one or more symbol items drawn by the dealer from the random symbol item storage, providing, and scanning device to the respective player symbol item sets of the two or more players, as indicated by chance-based transition P(On) 407. The multiplayer interactive electronic gaming table makes the assignment of the symbol items based on which player successfully selects the drawn symbol item through skillful play, as indicated by skill-based transition P(Ai) 413. If a player is successful in achieving the competitive multiplayer skill objective, then the multiplayer interactive electronic gaming table transitions to achievement state Af 410, as indicated by skill-based transition P(Af) 411. If a player is unsuccessful in achieving the competitive multiplayer skill objective, then the multiplayer interactive electronic gaming table transitions to loss state L 408 as indicated by skill-based transition P(L) 409.

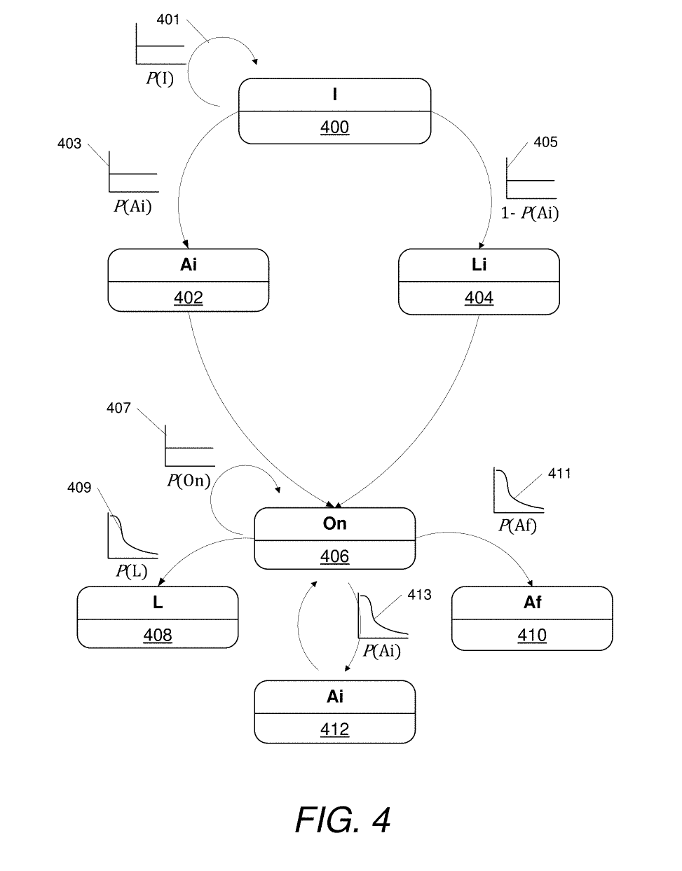

FIG. 5 is an activity diagram of an interactive wagering process of a multiplayer interactive electronic gaming table in accordance with various embodiments of the invention. The interactive wagering process is for a form of interactive poker implemented on the multiplayer interactive electronic gaming table wherein in the ranking of player symbol item sets is based on poker as described herein. After starting 500, in a side wager outcome determination of a house-banked side wager between players and an operator of the multiplayer interactive electronic gaming table, for each player playing 502, the electronic gaming table detects 504 that a symbol item has been provided from the random symbol item storage, providing, and scanning device and scans the random symbol item to determine the symbol on the drawn symbol item. The electronic gaming table communicates display data of the symbol determined from the drawn symbol item to one or more displays of the electronic gaming table to display the game state by displaying 506 the drawn symbol item. The multiplayer interactive electronic gaming table assigns 510 the symbol item to the set of symbol items of each player in turn. The multiplayer interactive electronic gaming table prompts the dealer to give the in-turn player the symbol item using a player respective portion of a dealer interactive interface as described herein.

Once each player has been assigned a symbol item, the electronic gaming table determines the game state by determining 513 if the symbol items assigned to the players belong to a specified subset of symbol items. If so 512, a payout is awarded 516 to each of the players, the game state is displayed, and the dealer is prompted to make the payouts to the players. If not 514, no payout is awarded to the players.

In a table-rake player versus player interactive wagering process of an interactive wagering game, the electronic gaming table detects 518 that a symbol item has been provided from the random symbol item storage, providing, and scanning device and scans the random symbol item to determine the symbol on the drawn symbol item. The electronic gaming table communicates display data of the symbol determined from the drawn symbol item to one or more displays of the electronic gaming table to display the game state by displaying 520 the drawn symbol item. The two or more players playing the interactive wagering game implemented on the electronic gaming table can use the one or more displays to decide if a player wants to select the drawn symbol item and add it to their set to symbol items.

The two or more players view the displayed symbol item and determine if they want the symbol item to be added to their respective own set of symbol items. If so, the two or more players use their respective player interactive interfaces to signal their selection of the displayed symbol item as described herein. The multiplayer interactive electronic gaming table receives the signaled selection of the displayed symbol item and assigns 524 the symbol item to the set of symbol items of the player who selected the symbol item, determines the game state by evaluating the player's symbol item set, displays the game state, and prompts the dealer to give the selecting player the selected symbol item using a player respective portion of a dealer interactive interface as described herein.

The electronic gaming table determines the game state by determining 525 if a player has a set of symbol items indicating a winning set of symbol items. If so 528, the electronic gaming table determines the game state by determining a payout that is to be paid to the player with the winning hand and prompts 532 the dealer to indicate that the player has a winning symbol item set using a player respective portion of a dealer interactive interface as described herein. If not 526, the electronic gaming table continues implementing the interactive wagering process by detecting 518 that the dealer has drawn an additional symbol item.

In some embodiments, the electronic gaming table continuously determines the game state by determining which player has a currently winning symbol item set and continuously displays to the players an indication of which player has the currently winning symbol item set.

In some embodiments, the symbol items are physical playing cards that are drawn by a dealer from an electronic card shoe that scans each card as it is drawn. In many such embodiments, two or more players compete to build the best set of symbol items in the form of a poker hand using the drawn cards. In some embodiments, the poker hand is a hand of 5 playing cards is in conventional poker. In some embodiments, the poker hand is a hand of 3 playing cards.

In some embodiments, the symbol items are playing cards and a specified subset of symbol items are face cards and a payout is awarded to each player if each player is assigned a face card. In some such embodiments, the number of face cards assigned to the players may be less than the number of players, that is not all players are required to be assigned face cards in order to be awarded a payout.

In some embodiments, if the electronic gaming table determines the game state by determining that no player has selected the symbol item, then the electronic gaming table receives the unselected symbol item into a drop box from the dealer. The process continues with an additional drawn symbol item being detected by the electronic gaming table.

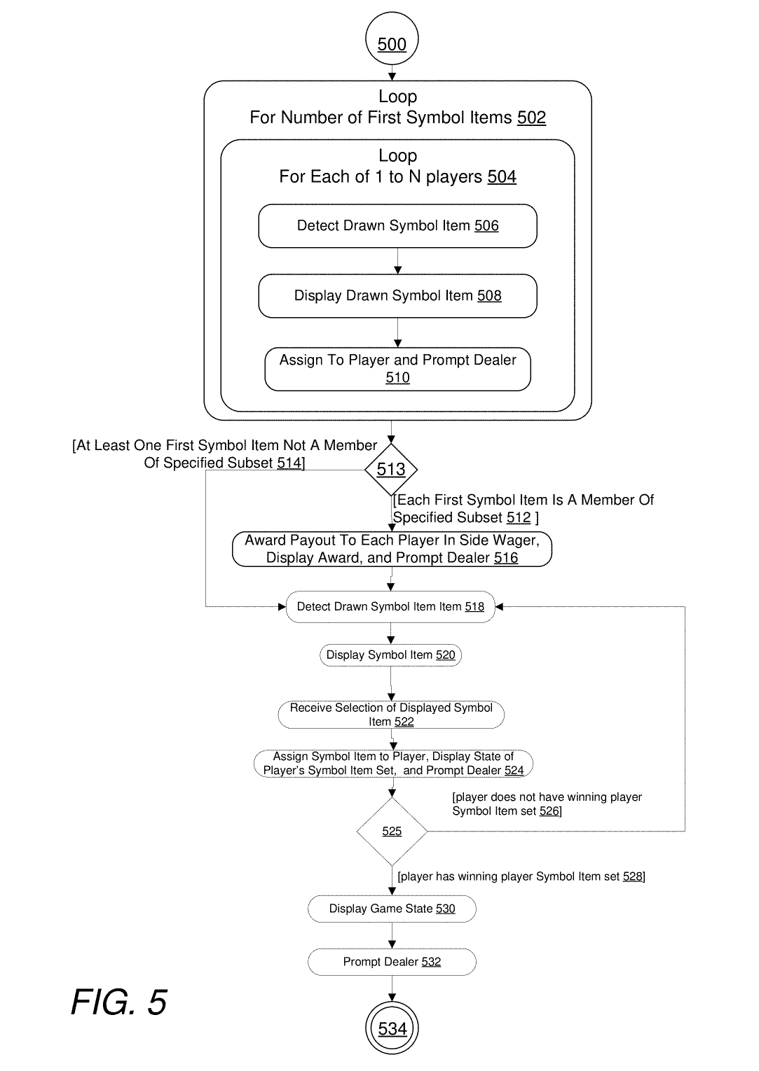

FIG. 6 is another activity diagram of an interactive wagering process of a multiplayer interactive electronic gaming table in accordance with various embodiments of the invention. The interactive wagering process is for a form of interactive poker implemented on the multiplayer interactive electronic gaming table wherein in the ranking of player symbol item sets is based on poker as described herein. The described process may be used with the process of FIG. 5. In the process, at the start 700 of the process, the electronic gaming table detects 702 that a symbol item has been drawn from the random symbol item storage, providing, and scanning device and scans the random symbol item to determine the symbol on the drawn symbol item. The electronic gaming table communicates display data of the symbol determined from the drawn symbol item to one or more displays of the electronic gaming table and displays the game state by displaying 704 the drawn symbol item to the players. The players playing an interactive wagering game implemented on the electronic gaming table can use the one or more displays to decide if the players want to select the drawn symbol item and add it to their set to symbol items.

The two or more players view the displayed symbol item and determine if they want the symbol item to be added to their respective own set of symbol items. If so, the two or more players use their respective player interactive interfaces to signal their selection of the displayed symbol item. The electronic gaming table receives 706 the signaled selection of the displayed symbol item and assigns 708 the symbol item to the set of symbol items of the player who selected the symbol item and prompts the dealer 710 using a player associated portion of a dealer interactive interface as described herein. The electronic gaming table determines a game state by determining 711 if any player has a complete set of symbol items of a specified number of symbol items. If so 714, the electronic gaming table determines 716 a set number of additional symbol items to be displayed as a “burn down” of any remaining randomized symbol items in the random symbol item storage, providing, and scanning device. The electronic gaming table prompts 718 the dealer as to the remaining number of symbol items to be drawn and displays the game state by displaying the same information to the players.

The electronic gaming table detects 720 that a symbol item has been from the random symbol item storage, providing, and scanning device and scans the random symbol item to determine the symbol on the drawn symbol item. The electronic gaming table communicates display data of the symbol determined from the drawn symbol item to one or more displays of the electronic gaming table to display 722 the symbol item to the players.

The players view the displayed symbol item and determine if they want the symbol item to be added to their respective own set of symbol items. If so, the players use their respective player interactive interfaces to signal their selection of the displayed symbol item. The electronic gaming table receives 724 the signaled selection of the displayed symbol item and assigns 726 the symbol item to the set of symbol items of the player who selected the symbol item. The electronic gaming table determines the game state by determining 727 if the set number of symbol items have been drawn and displayed to the players. If not 728, the electronic table game continues by detecting additional drawn symbol items. If the set number of symbol items have been drawn and displayed to the players 730, the electronic gaming table determines the game state by determining 732 a credit payout that is to be paid to the player with a winning set of symbol items and prompts the dealer as to the identity of that player using a player associated portion of a dealer interactive interface.

In some embodiments, the dealer prompts included audio prompts as well as a visual prompts. One or more audio output devices are commanded to prompt the dealer to provide a drawn symbol item that was selected by the player, to prompt the dealer to provide a payout when a player has successfully achieved an objective of the interactive wagering process, and to prompt the dealer when a player is no longer allowed to participate in the interactive wagering process.

In some embodiments, during the burn down process, the electronic gaming table determines from the game state of the interactive wagering game if any of the player's can complete a symbol item set that can be ranked higher than the symbol item set held by the player with the complete set of symbol items. In an example embodiment, the symbol items are playing cards, the symbol item sets are hands, and the interactive wagering process uses the ranking of poker hands to determine a winning hand, if the player with the complete hand has a royal flush and all of the other players have at least one card in their respective hands having a value of 2 to 9, then there is no way that any of the other players can possibly build a better hand. If there is no possibility that another player will beat the hand of the player with the complete hand, then the electronic gaming table determines the game state by determining a credit payout that is to be paid to the player with the winning hand and terminates the interactive wagering process.

In some embodiments, a multiplayer interactive electronic gaming table inhibits further play by a player if the player has no opportunity to win. In such a process, the multiplayer interactive electronic gaming table detects that a drawn symbol item has been selected by a player. The multiplayer interactive electronic gaming table assigns the selected symbol item to the selecting player. The multiplayer interactive electronic gaming table evaluates all player symbol item sets and identifies a currently winning player or players having the highest ranking player symbol item set or sets. For each other player, the multiplayer interactive electronic gaming table determines the game state by determining if that player's symbol item set can be the basis for a same or higher ranking symbol item set as the currently winning player or players' symbol item set or sets. If the player's symbol item set cannot be the basis for a same or higher ranking symbol item set as the currently winning player or players' symbol item set or sets, the multiplayer interactive electronic gaming table disables that player's user input device such that the player can no longer select drawn symbol items. In some embodiments, the player's user input device also visually indicates that the user input device is disabled. In some embodiments, the user input device visually indicates that the user input device is disabled by a lighted indicator such as a flashing light or the like. If the player's symbol item set can be the basis for a same or higher ranking symbol item set as the currently winning player or players' symbol item set or sets, the player is allowed to continue selecting drawn symbol items in an effort to build a winning set of symbol items. In an example embodiment, a set of symbol items is a deck of playing cards having four suits (e.g. clubs, diamonds, hearts, and spades) and thirteen valued cards (e.g. Ace, 2, 4, 5, 6, 7, 8, 9, Jack, Queen, and King). A game implemented by a multiplayer interactive electronic gaming table is three card poker, accordingly a set of symbol items or hand for each player can include 1, 2 or 3 cards. A ranking of hands in 3 card poker form lowest to highest is: high card, pair, flush, straight, three of a kind, straight flush. During game play, each player is dealt a single card to start. As an example embodiment, if a first player selects a second and third card and makes a hand of 3 of a kind, a second player with a 2 and a 3 of different suits will not be able to select one more card that will allow the second player to build a hand that outranks a hand of three of a kind as the only possible higher ranked hand is a straight flush and the second player can no longer make a straight flush as the second player's two cards are of different suits.

In other embodiments, an interactive wagering game implemented by a multiplayer interactive electronic gaming table has multiple ways for a player to win. A primary wager is a wager in a competitive skill game where players compete to be the first to collect cards adding up to a sum of a dealer's cards. A side wager is entirely chance-based wherein all players may win the side wager.

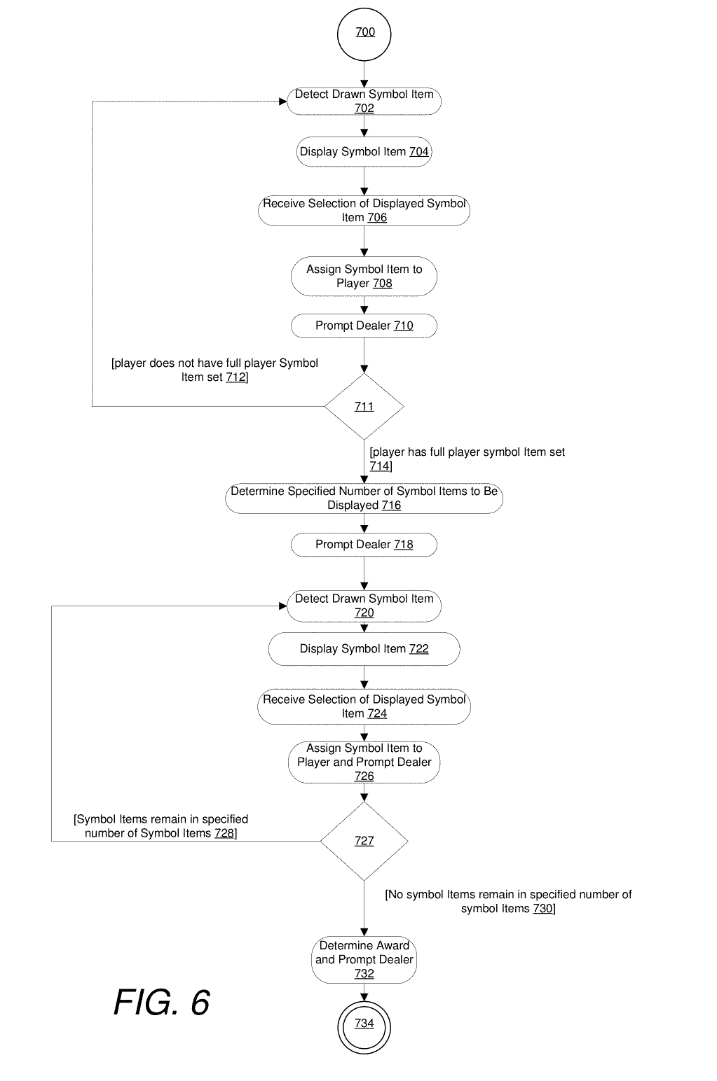

FIG. 7 is another state diagram of an interactive wagering process of a multiplayer interactive electronic gaming table during an interactive wagering process in accordance with various embodiments of the invention. The interactive wagering process is for a form of Black Jack or 21 implemented on the multiplayer interactive electronic gaming table wherein in the ranking of player symbol item sets is based on a point set by a dealer's symbol item set as described herein. In an example embodiment, during an initial symbol item assignment subprocess, the multiplayer interactive electronic gaming table assigns one more initial symbol items to a dealer symbol item set. A completed dealer symbol item set determines the game state by determining a competitive multiplayer skill objective to be achieved by two or more players.

In some embodiments, a house-banked side wager is implemented such that if a dealer's completed dealer symbol item set meets a specified ranking criteria, each player of the interactive wagering process in awarded a payout.

In some embodiments, a house-banked side wager is implemented such that if a dealer's completed dealer symbol item set meets a specified ranking criteria, all of the players of the interactive wagering process are determined to have lost the interactive wagering process.

Subsequently, in a competitive interactive wagering subprocess, additional symbol items are drawn by a dealer and presented by the multiplayer interactive electronic gaming table to the two or more players. The two or more players compete to select the drawn and presented symbol items to add to their respective player symbol item sets in order to achieve the multiplayer competitive skill objective. After all players have had a chance to obtain a player symbol item set, the multiplayer interactive electronic gaming table ranks the player symbol item sets and a player with a highest ranked player symbol item set is declared a winner and awarded an award. In some embodiments, the initial symbol item assignment subprocess to the dealer symbol item set by the multiplayer interactive electronic gaming table is a basis of a house-banked wager. In various embodiments, the player versus player interactive subprocess, is a basis for a house-rake player versus player competitive wager.

In some embodiments, the symbol items are playing cards having four suits with each suit including an ace, three face cards, namely a king; a queen; and a jack; and 9 valued non-face cards having values of 10; 9; 8; 7; 6; 5; 4; 3; and 2. In various embodiments, the symbol items items have values assigned to them such that an ace is valued at either 1 or 11 points, a face card is valued at 10 points, and each of the non-face valued cards has a respective point value of the value of the playing card. A valuation of a symbol item set is performed by summing the values of the symbol items in the symbol item set. An ace symbol is valued at either 11 points or 1 point, depending on which value is more advantageous to a respective player or dealer. In some embodiments, the multiplayer skill objective is set by a valuation of the dealer symbol item set. In various embodiments, players compete to build a player symbol item set with a value that is equal to or less than a target value of the dealer symbol item set. In many embodiments, if a player builds a player symbol item set equal to the target value of the multiplayer skill objective, that player's player symbol item set is deemed the highest ranking symbol item set. If no player is able to build a player symbol item set having a valuation equal to the target value of the multiplayer sill objective, then a player whose symbol item set has a value that is closest to the target value of all other player symbol item sets will be deemed the highest ranking symbol item set.

During the interactive wagering process, in an initial state I 1200, a dealer draws symbol items from a randomized set of symbol items stored in a random symbol item storage, providing, and scanning device. The multiplayer interactive electronic gaming table assigns at least one symbol item to a dealer symbol item set. A valuation of the dealer symbol item set is used as a target value of a competitive multiplayer skill objective. In addition, the dealer symbol item set is used as a basis for determining an outcome of a wager between an operator of the multiplayer interactive electronic gaming table and the two or more players. The initial drawing of the symbol items is chance-based as indicated by chance-based transition P(I) 1201, and forms the basis of determining an achievement of a chance-based objective of the two or more player's winning a side wager against an operator of the multiplayer interactive electronic gaming table. If the chance-based objective is achieved, the multiplayer interactive electronic gaming table transitions, as indicated by chance-based transition P(Ai) 1203 to an objective achievement state Ai 1202, and each of the two or more players is awarded an award. However, if the chance-based objective is not achieved, the multiplayer interactive electronic gaming table transitions to an intermediate loss state Li 1204 as indicated by chance-based transition P(Li) 1205.

The initial drawing of the symbol items for the dealer symbol item set also forms the basis of determining an achievement of a chance-based objective of the operator of the two or more player's losing a side wager against the operator of the multiplayer interactive electronic gaming table. If the chance-based objective is achieved, the multiplayer interactive electronic gaming table transitions, as indicated by chance-based transition P(L2) 1207 to loss state L1 1206, and each of the two or more players loses the interactive wagering game and the interactive wagering process is ended.

From either state Ai 1202 or Li 1204, the multiplayer interactive electronic gaming table transitions to a skill-based objective state On 1208 where the two or more player's attempt to skillfully achieve a competitive multiplayer skill objective. While in state On 1208, the multiplayer interactive electronic gaming table assigns one or more symbol items drawn by the dealer from the random symbol item storage, providing, and scanning device to the respective player symbol item sets of the two or more players, as indicated by chance-based transition P(On) 1209. The multiplayer interactive electronic gaming table makes the assignment based on which player successfully selects a drawn symbol item through skillful play of competing to select the displayed symbol item, as indicated by skill-based transition P(Ai) 1213 to intermediate skill achievement state Ai 1212. If a player is successful in achieving the competitive multiplayer skill objective, then the multiplayer interactive electronic gaming table transitions to achievement state Af 1214, as indicated by skill-based transition P(Af) 1215. If a player is unsuccessful in achieving the competitive multiplayer skill objective, then the multiplayer interactive electronic gaming table transitions to loss state L2 1210 as indicated by skill-based transition P(L2) 1211.

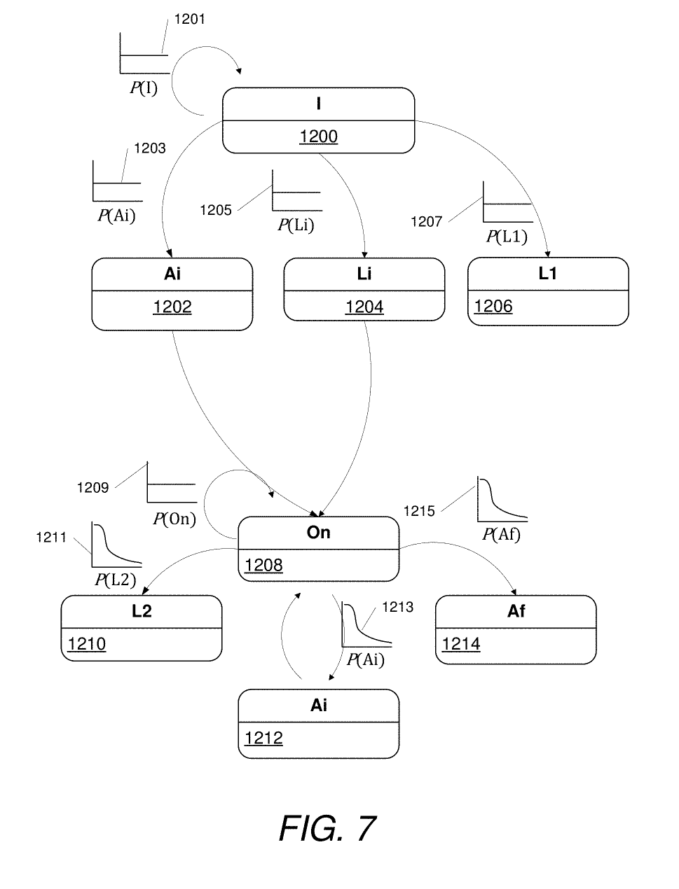

FIGS. 8A and 8B are activity diagrams of a multiplayer interactive electronic gaming table during another interactive wagering process in accordance with various embodiments of the invention. The interactive wagering process is for a form of Black Jack or 21 implemented on the multiplayer interactive electronic gaming table wherein in the ranking of player symbol item sets is based on a point set by a dealer's symbol item set as described herein. After a start 1300 of the process, during the interactive wagering process, the multiplayer interactive electronic gaming table detects 1302 a drawn symbol item. The multiplayer interactive electronic gaming table assigns 1304 the drawn symbol item to a dealer symbol item set.

The multiplayer interactive electronic gaming table determines a game state by evaluating 1306 the dealer's symbol item set. If the dealer symbol item set is not complete 1308, the multiplayer interactive electronic gaming table detects additional drawn symbol items to be added to the dealer symbol item set. If the dealer symbol item set is complete and the dealer symbol item set fails to meet a specified criteria 1310, then an outcome is determined for a house-banked side wager between the operator of the multiplayer interactive electronic gaming table and the players, and an award is determined and awarded to any players who have committed to the side wager. If the dealer symbol item set does meet the specified criteria 1312, then no determination of a side wager award is made. Whether or not the specified criteria is met by the dealer symbol item set, a target value for a competitive multiplayer skill object is determined 1316 from a valuation of the dealer symbol item set as described herein. The multiplayer interactive electronic gaming table updates 1318 one or more interactive interfaces and one or more displays based on the state of the interactive wagering process. The process continues 1330 as described in FIG. 8B

In many embodiments the state of the interactive wagering process includes the target value and a number of players who will be participating in the competitive multiplayer skill objective. The target value is displayed to the players and each players' respective interactive interface is activated so that each player may use their respective interactive interface to select symbol items as they are drawn and displayed.

Referring now to FIG. 8B, continuing 1330 from FIG. 8A, the multiplayer interactive electronic gaming table determines the game state by determining 1331 if there are additional symbol items stored in the random symbol item storage, providing, and scanning device. If so 1334, the multiplayer interactive electronic gaming table detects 1336 a drawn symbol item and displays the game state by displaying the symbol item to the players using the multiplayer interactive electronic gaming table's one or more displays. When the multiplayer interactive electronic gaming table determines the game state by detecting 1337 that the displayed symbol item is selected by a player 1340, then the multiplayer interactive electronic gaming table updates 1344 the interactive interfaces of any other players to indicate that the symbol item has been selected by a player. In some embodiments, the multiplayer interactive electronic gaming table also prompts the dealer by updating an interactive interface of the dealer to indicate which player has selected the symbol item as described herein.

The multiplayer interactive electronic gaming table determines the game state by determining, 1341a and 1341b, a value of the selecting player's symbol item set. If the value of the player's symbol item set is less than a target value 1342, then the multiplayer interactive electronic gaming table continues detecting 1331 additional drawn symbol items as long as there are symbol items remaining to be drawn. If the value of the selecting player's symbol item set is not less than the target value 1346 and the value of the selecting player's symbol item set is greater than the target value 1348, then the multiplayer interactive electronic gaming table locks out 1350 the selecting player from additional play and updates the player respective portion of the dealer interactive interface and that player's interactive interface to indicate to both the dealer and the selecting player that the selecting player is locked out from further play as described herein. If the value of the selecting player's symbol item set is equal to the target value 1352, then the multiplayer interactive electronic gaming table determines the game state by determining 1354 that the selecting player is a winning player and updates 1356 the interactive interfaces of the players and the dealer to prompt the dealer and to indicate that a player has achieved the multiplayer skill objective of building a player symbol item set with a valuation equal to the target value as described herein.

If the multiplayer interactive electronic gaming table detects 1338 that no players have selected a displayed symbol item, the multiplayer interactive electronic gaming table continues detecting drawn symbol items until there are no symbol items left to be drawn. If there are no symbol items left to drawn 1332 and no player has achieved the competitive multiplayer skill objective, then the multiplayer interactive electronic gaming table determines the game state by determining 1354 a winning player from among any players who have not been locked out from further play.

In some embodiments, the winning player is determined as the player who has come closest to the target value set by the dealer's symbol item set.

In some embodiments, dealer prompts included audio prompts as well as a visual prompts. One or more audio output devices are commanded to prompt the dealer to provide a drawn symbol item that was selected by the player, to prompt the dealer to provide a payout when a player has successfully achieved an objective of the interactive wagering process, and to prompt the dealer when a player is no longer allowed to participate in the interactive wagering process.

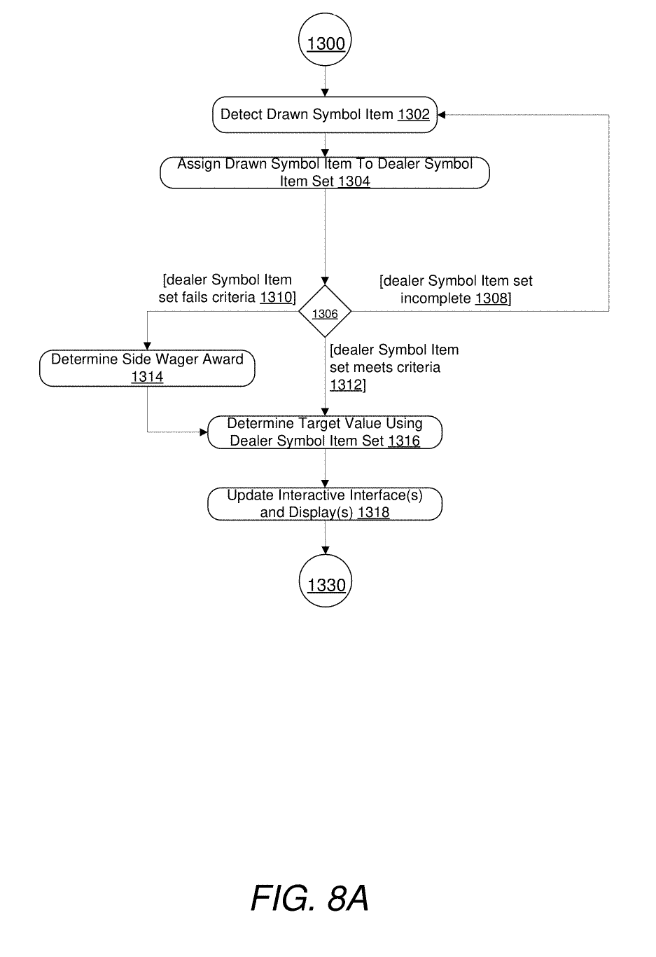

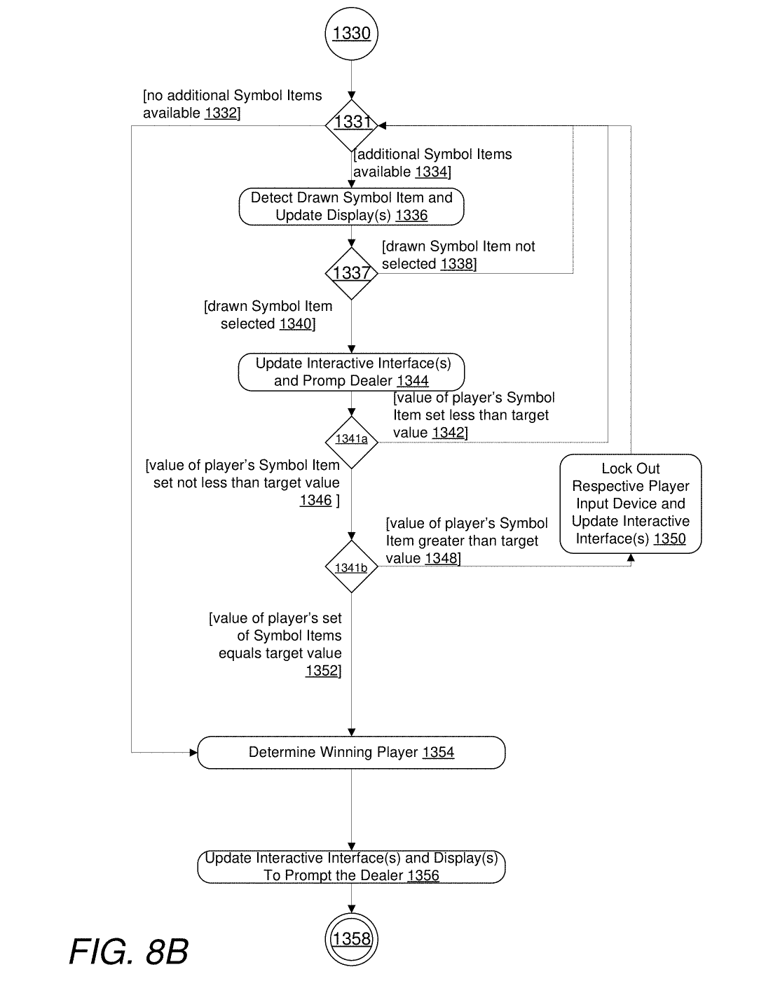

FIG. 9A is an illustration of a playing surface of a multiplayer interactive electronic gaming table in accordance with various embodiments of the invention. As illustrated, playing surface 1400 is for a multiplayer interactive wagering game in the form of interactive poker implemented on the multiplayer interactive electronic gaming table wherein in the ranking of player symbol item sets is based on poker as described herein.

FIG. 9B is an illustration of a display of a multiplayer interactive electronic gaming table in accordance with various embodiments of the invention. As illustrated, display 1402 is for a multiplayer interactive wagering game in the form of interactive poker implemented on the multiplayer interactive electronic gaming table wherein in the ranking of player symbol item sets is based on poker as described herein.

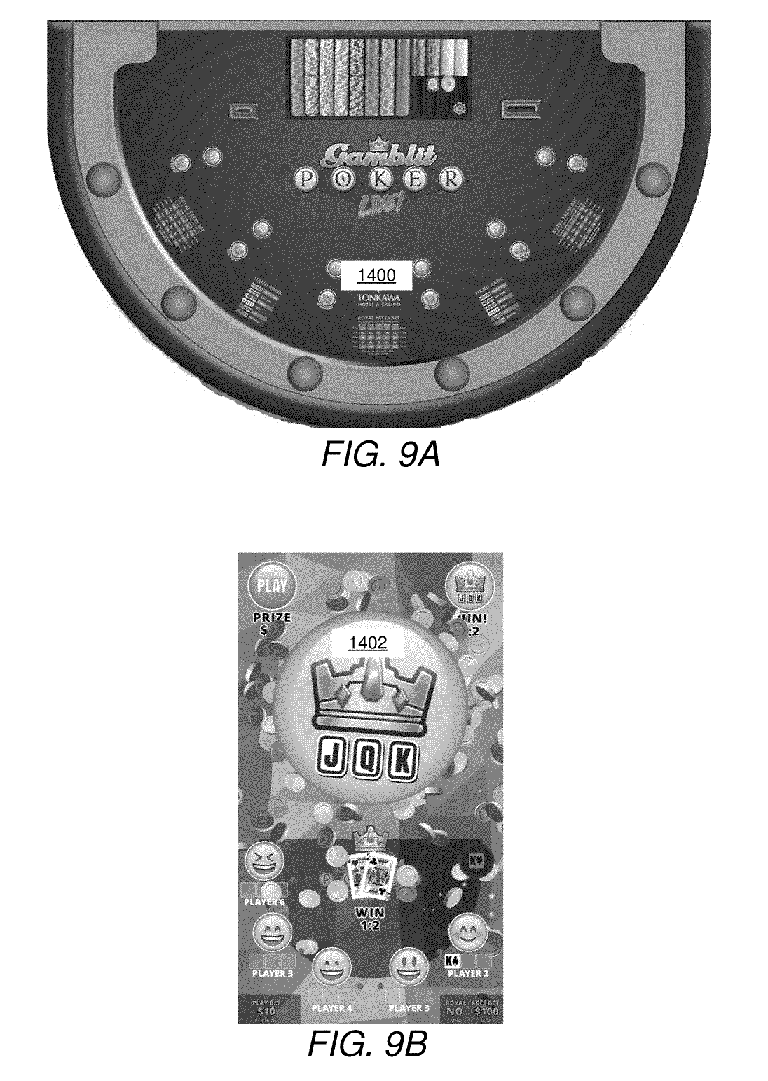

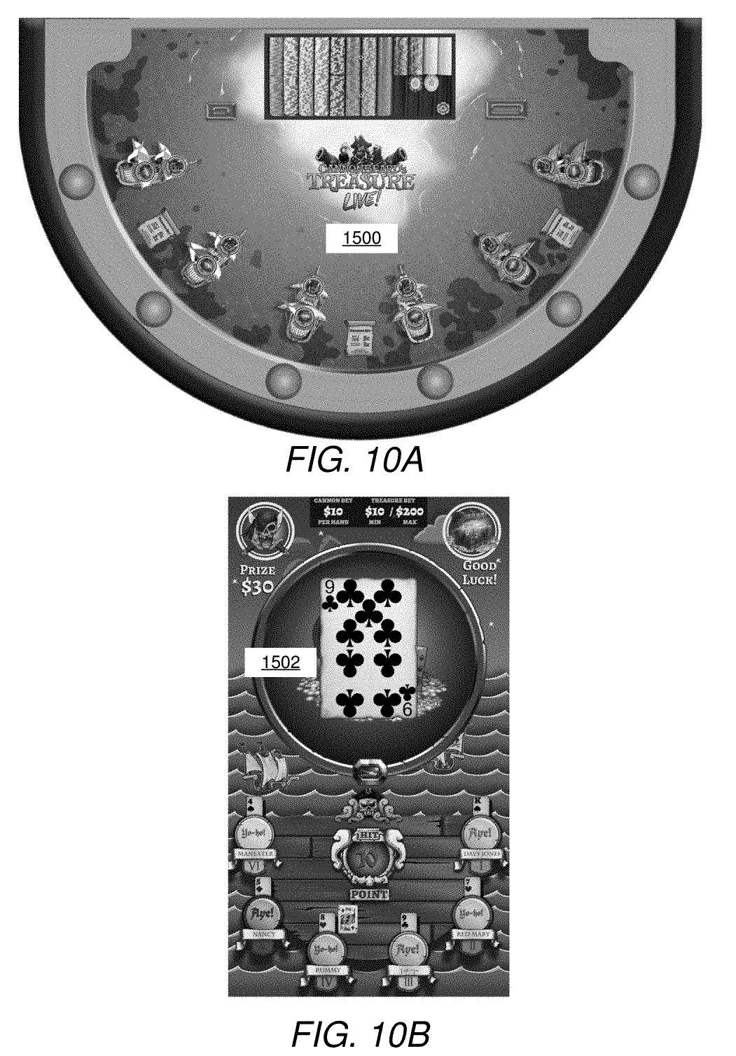

FIG. 10A is an illustration of another playing surface of a multiplayer interactive electronic gaming table in accordance with various embodiments of the invention. As illustrated, playing surface 1500 is for a multiplayer interactive wagering game in the form of interactive Black Jack or 21 implemented on the multiplayer interactive electronic gaming table wherein in the ranking of player symbol item sets is based on achieving a point set by a dealer's symbol item set as described herein.

FIG. 10B is an illustration of another display of a multiplayer interactive electronic gaming table in accordance with various embodiments of the invention. As illustrated, display 1502 is for a multiplayer interactive wagering game in the form of interactive Black Jack or 21 implemented on the multiplayer interactive electronic gaming table wherein in the ranking of player symbol item sets is based on achieving a point set by a dealer's symbol item set as described herein.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A multiplayer interactive electronic gaming table, comprising:
an electronic gaming table controller;
a symbol item storage device operatively connected to the electronic gaming table;
one or more displays operatively connected to the electronic gaming table controller;
two or more player interactive interfaces; and
a latching circuit operatively connecting the two or more player interactive interfaces to the electronic gaming table controller, wherein the electronic gaming table controller is configured to:
receive symbol data from the symbol storage device for a drawn symbol item;
display the symbol data on the one or more displays;
receive a player selection of the symbol item from one of the two or more player interactive interfaces via the latching circuit;
assign the symbol item to a set of player symbol items associated with the player;
prompt a dealer to provide the symbol item to the player;
determine a game state using the symbol data; and
display the game state using the one or more displays.

2. The multiplayer interactive electronic gaming table of claim 1, further comprising a dealer interactive interface.

3. The multiplayer interactive electronic gaming table of claim 2, wherein the multiplayer interactive electronic gaming table controller is further configured to use the dealer interactive interface to prompt the dealer.

4. The multiplayer interactive electronic gaming table of claim 1, wherein the multiplayer interactive electronic gaming table controller is further configured to implement an interactive wagering process for an interactive wagering game.

5. The multiplayer interactive electronic gaming table of claim 4, wherein the interactive wagering game is in the form of interactive poker.

6. The multiplayer interactive electronic gaming table of claim 4, wherein the interactive wagering game is in the form of interactive Black Jack.
